(19) United States
(12) Patent Application Publication
(10) Pub. No.: US 2014/0172683 A1
(43) Pub. Date: Jun. 19, 2014

(54) LOSS TOLERANCE METHODOLOGY

(71) Applicant: PIEtech, Inc., Powhatan, VA (US)

(72) Inventor: Robert D. Curtis, Powhatan, VA (US)

(73) Assignee: PIEtech, Inc., Powhatan, VA (US)

(21) Appl. No.: 14/104,041

(22) Filed: Dec. 12, 2013

Related U.S. Application Data
(60) Provisional application No. 61/737,402, filed on Dec. 14, 2012.

(51) Int. Cl. G06Q 40/02

(52) U.S. Cl. CPC G06Q 40/025
USPC 705/38

(57) ABSTRACT

A method for determining financial risk tolerance for individuals is characterized by the display of portfolio allocations, potential portfolio losses, and demographic comparisons based on a risk score. The visualization of potential losses, which are based on losses to a hypothetical portfolio in a recent downturn market, help an individual better understand his or her comfort level with various investment strategies. This method is of particular benefit to financial advisors for use with their clients so that client specific investment strategies can more easily be formulated.

This application claims the benefit of provisional application No. 61/737,402 which was filed Dec. 14, 2012.

### BACKGROUND OF THE INVENTION

In the investment industry, a financial advisor in conjunction with a client must decide how to invest the client's money. Generally, the advisor and client first agree on an appropriate asset allocation (the mix of asset classes and the relative percentage that each class will comprise in the overall portfolio), and then select the investments to be purchased that correspond to the classes chosen. The present invention relates to the first of these steps—how to effectively choose the appropriate asset allocation portfolio.

Since both the future rates of return and the volatility of all investments are unknown, the rates of return and volatility of all asset allocation portfolios are also unknown. A financial advisor uses a combination of historical past performance data and projected data to provide possible return and volatility assumptions for a portfolio. The portfolio selection is a trade-off between risk and return, and a key determinate in the portfolio selection is the client's risk tolerance, i.e. the client's willingness to risk a loss on an original investment in exchange for a more favorable financial return.

The process of choosing an asset allocation portfolio has evolved into two separate steps: 1) determining the client's risk tolerance; and 2) mapping that risk tolerance to a portfolio.

### BRIEF DESCRIPTION OF THE PRIOR ART

In general, to determine a client's risk tolerance, advisors use discussions (either open-ended or targeted) or risk tolerance questionnaires. Risk tolerance questionnaires typically include multiple-choice questions that the client answers. The results are numerically scored and summarized, generally as a single number, which the financial advisor uses as the client's specific risk tolerance. For example, a risk tolerance of 2 might be conservative, whereas a risk tolerance of 8 would indicate an aggressive investor. Unfortunately, research has shown that interviews and questionnaires have essential flaws for determining risk tolerance.

One important flaw in most questionnaires is that they do not assess the psychological aspects of risk tolerance. The scientific discipline called psychometrics tests soft attributes such as risk tolerance. Psychometrics is a blend of psychology and statistics, and it provides methodologies for developing tests and standards against which the efficacy of tests can be evaluated. In the United States, psychometric testing for personality generally, and attributes such as risk tolerance specifically, is still in its infancy in financial services. One such psychometric questionnaire is the FinaMetrica Risk Profiling System which is being used in the United States only on a limited basis. The FinaMetrica system is expensive and also requires a substantial time commitment from both the financial advisors and their clients.

Research has also shown that discussions between advisors and their clients to determine the client's risk tolerance are not always reliable, which indicates that a valid measure of risk tolerance is needed prior to providing financial advice and guidance. Generally, individuals tend to be better judges of their own risk tolerance than the tolerance of someone else, and thus individuals are better than their advisors at assessing their risk tolerance.

Even if a valid questionnaire is used with a client, the advisor still has to determine how to use the resulting risk tolerance score to select an asset allocation portfolio. If a too conservative portfolio is chosen, the client gives up the opportunity for higher returns, portfolio growth, and having more money to fund financial goals. If a too aggressive portfolio is chosen, the investor may panic with a loss and sell out at the worst time—when the portfolio is at its lowest.

Accordingly, there is a need for a reliable method for determining an individual's risk tolerance as it relates to financial investing. Research has also shown that the second step—using the risk tolerance score to select an appropriate portfolio—is also flawed, thus creating a need for a better tie-in for portfolio allocation as a function of risk tolerance.

### SUMMARY OF THE INVENTION

One primary objective of the present invention is to combine the standard two-step process into one step by merging the client's risk assessment with the selection of an asset allocation portfolio.

A second objective is to focus on loss tolerance rather than risk tolerance. Loss tolerance is a determination of how much a client is willing to lose and still stay invested in a particular portfolio. Loss tolerance is sometimes used as one factor in conducting a risk assessment. Other factors may include risk tolerance (a psychological trait), risk capacity (how much risk an individual can afford to take), and perceived risk (the potential that an individual's perception of risk may vary over time based on external conditions).

In accordance with the inventive method, a client selects a candidate risk score, and an electronic device displays two important data points: an asset allocation portfolio and the actual loss that such a portfolio sustained in a recent down market. If the client would be willing to accept a loss of this magnitude (if a similar down market were to occur in the future), then the portfolio is selected. If the client would not be willing to accept a loss of this magnitude, then the client selects another candidate risk score, and the asset allocation portfolio and the actual down market loss associated with this new score are displayed by the electronic device. This process continues iteratively until the electronic device displays an asset allocation portfolio with an actual loss that the client would be willing to accept.

In accordance with another objective of the invention, the electronic device can also display the risk scores of others in similar demographics (including, for example, age, gender, and marital status) as the client, and may also provide a quantitative or qualitative comparison of the client's risk score to the scores of the others in the demographic group or groups. After reviewing this comparison, the client may choose to adjust his or her risk score and continue to iterate this process.

It is another objective of the invention to take the separate risk scores from more than one client, such as the scores from a married couple, and combine them to generate a loss tolerance analysis for the couple.

### BRIEF DESCRIPTION OF THE FIGURES

Other objectives and advantages of the invention will become apparent from a study of the following specification when viewed in the light of the accompanying drawing in which:

FIG. 1 is a flow chart illustrating the steps of the loss tolerance determination method according to the invention;

FIG. 2 is an illustration of a system used by a client to select his or her risk score;

FIGS. 3 and 4 are example illustrations of a portfolio allocation, loss indication, and demographic comparison for different selected risk scores, respectively; and

FIG. 5 is an illustration of the portfolio allocation and loss indication for the combined risk scores of FIGS. 3 and 4.

### DETAILED DESCRIPTION

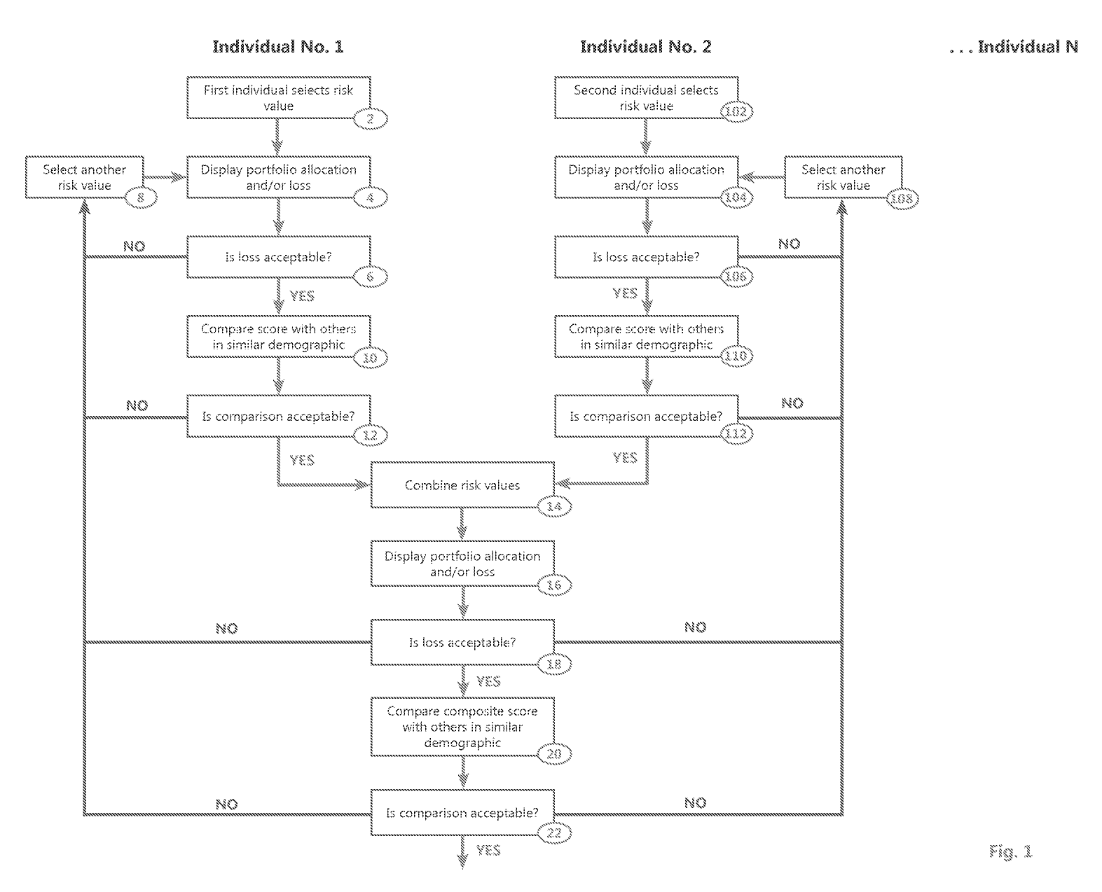

The method for determining financial risk tolerance according to the invention is particularly useful for financial advisors in dealing with clients. By assisting the client to consider his or her personal loss tolerance (a more specific factor than risk tolerance and one that is more easily measurable), the financial advisor is better able to tailor an investment plan according to the needs and comfort level of the client. One of the worst outcomes for clients is to panic during a down market and sell at the market low, thus locking in their losses. Using a loss tolerance assessment helps to prevent such an outcome. The method will be described with reference to FIG. 1.

Although the illustrative embodiment will be generally described in the context of program modules running on a personal computer or other electronic device such as a tablet or smart phone, those skilled in the art will recognize that the present invention may be implemented in conjunction with operating system programs or with other types of program modules for other types of computers. Furthermore, those skilled in the art will recognize that the present invention may be implemented in either a stand-alone or in a distributed computing environment or both. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general-purpose machines may be used with the program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

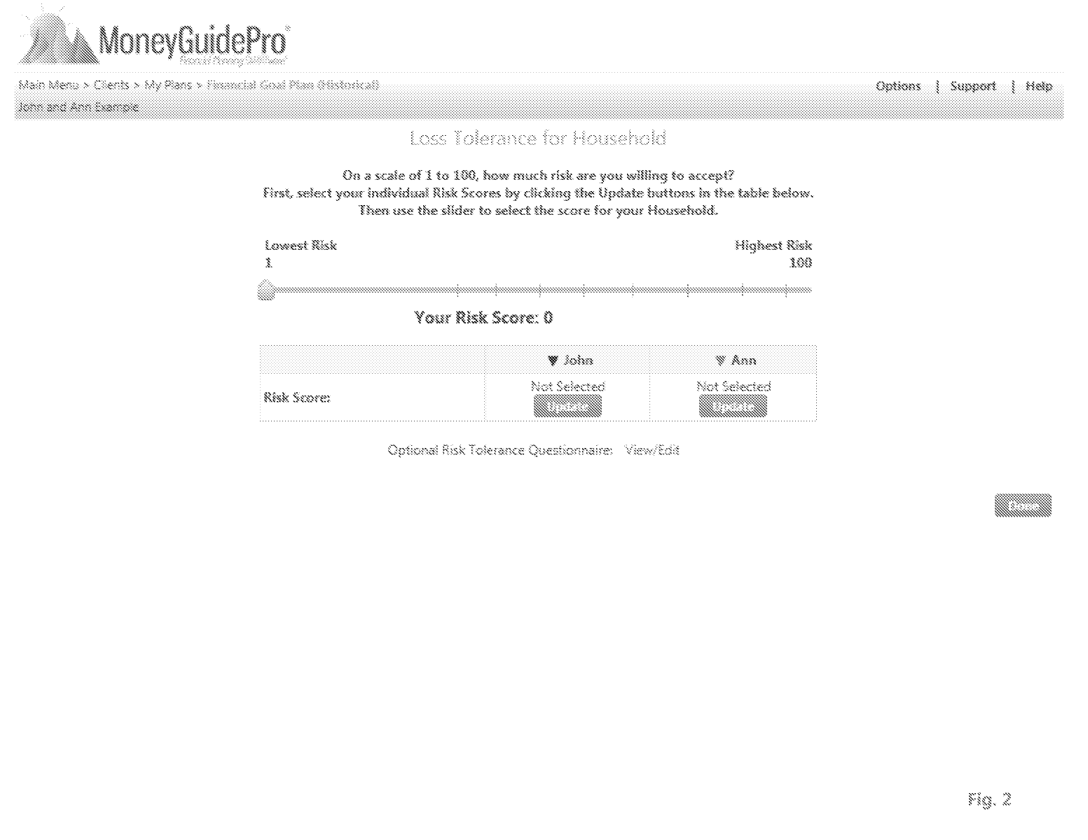

An individual initially interacts with a software program or application on an electronic device such as a computer to select a candidate risk score. An example electronic device display is shown in FIG. 2. In this example, a risk scale is indicated having a value from 1 for the lowest risk to 100 for the highest risk. Other risk scales can also be used. Also in this example, the individual selects a candidate score using a slider bar, and then presses the update button to select the score. Other methods of selecting a risk score can also be used. This step is indicated by the box 2 in FIG. 1.

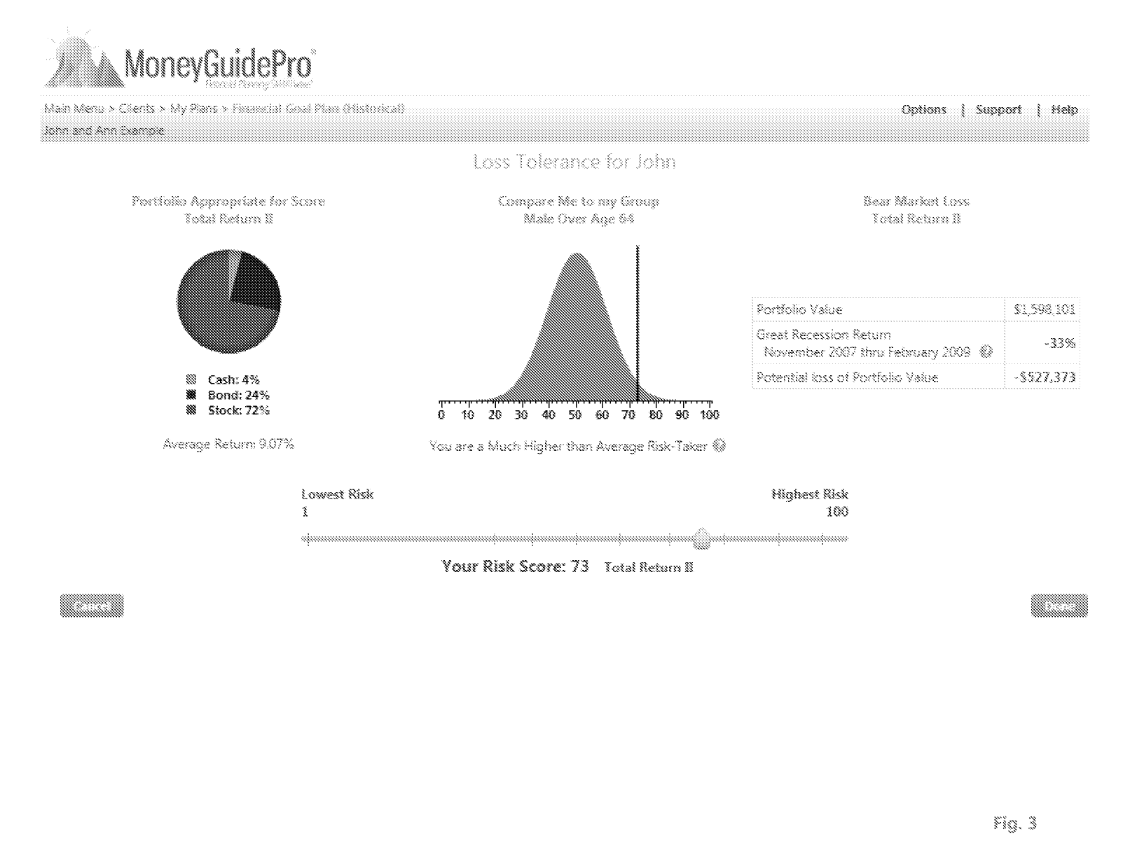

Based on the candidate score, the electronic device displays a portfolio allocation as shown in FIG. 3. In this example, the allocation is divided on a percentage basis among cash, stocks, and bonds. A more detailed portfolio allocation where cash, stocks, and bonds are further sub-divided into more detailed asset classes can also be used The electronic device also displays the loss that would have occurred for this portfolio allocation from a known prior down market. The time period used for the prior down market is a variable in the methodology. It could be, for example: (i) the worst annual return in the last ten, twenty or thirty years; (ii) the worst consecutive two-year return in the last ten, twenty or thirty years; or (iii) the return from the most recent recessionary period, which may be more or less than a year, and which may be selected based on different definitions of recessionary periods.

The portfolio loss can be displayed as a percentage or as a dollar amount of the value of the portfolio. If a dollar amount is used, the value of the portfolio is the total current value of the individual's portfolio. The display of the portfolio allocation and potential loss is shown by step 4 in FIG. 1. Separate displays of the allocation and loss can be made for ease of the client's understanding, or both may be displayed together as shown in FIG. 3.

The individual reviews the loss and makes a personal determination at step 6 in FIG. 1 as to whether the loss is acceptable to him or her.

If the loss is not acceptable, the individual has the option at step 8 of FIG. 1 of selecting a new candidate risk score. Doing so causes the electronic device to display a new portfolio allocation based on the new score. Similarly, a new portfolio loss amount, either as a percentage or as a dollar value or both, is displayed to the individual. The individual continues to select candidate risk scores, iteratively, until the electronic device displays a portfolio that has an associated potential loss that is acceptable to the individual.

Once the electronic device displays a portfolio that has an associated potential loss that is acceptable, the individual has the option to view the risk values or scores from various demographic groups for comparison (at step 10 shown in FIG. 1) to further assist the individual with making a risk score selection. The demographic scores are compiled from prior scores established by other individuals. The demographics can be based on any number of characteristics of the individuals, including factors such as age, gender, and marital status. The compilation of scores may be displayed graphically on the risk score scale as shown in FIG. 3. The comparison may also include a quantitative component, such as “Fifty-five percent (55%) of the people in this group are higher risk takers than you,” or may include a qualitative component, such as “You are a higher than average risk taker.” In the example shown, for the individual identified as John, his score of 73 is shown to be at the high end of the scale in comparison to others in his age group. If John is not satisfied with the comparison, he has the option at step 8 of FIG. 1 to select another risk score. Doing so can change the portfolio allocation, the loss values, and the demographic comparison shown in FIG. 3 according to the new risk score selected.

In the example shown, the demographic comparison is shown on the same screen as the portfolio allocation and the potential portfolio loss. Each of these data (the portfolio, the potential loss, and the demographic comparison) can also be shown separately.

Once the electronic device has displayed a portfolio that is acceptable to the individual (either because the potential loss is acceptable, or the demographic comparison is satisfactory, or both) at step 12 of FIG. 1, the individual can consult with the financial advisor to invest his or her funds in products which match the portfolio allocation.

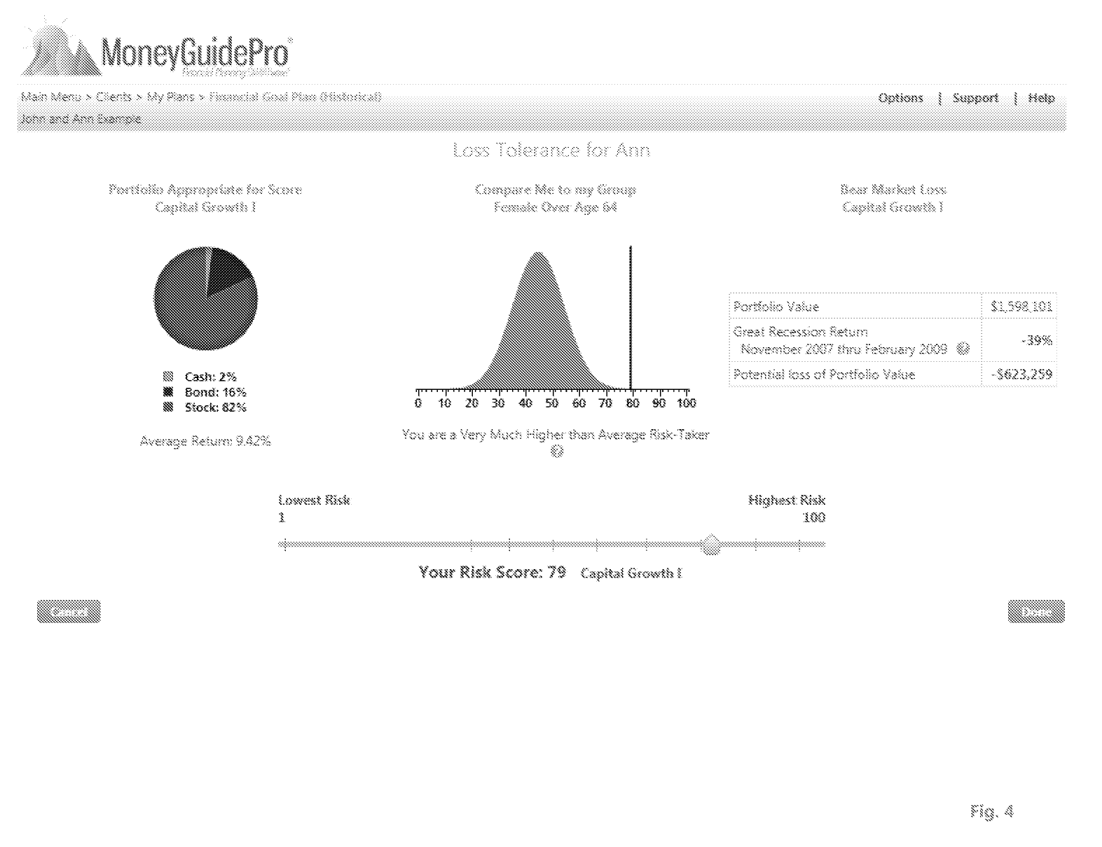

According to another aspect of the invention, a second individual can select a risk score using the same sequence of steps as the first individual, as shown in FIG. 1. That is, the second individual selects a personal risk value or score at step 102. In the example shown, for an individual identified as Ann in FIG. 4, the selected risk score is 79. The portfolio allocation for the selected value and the portfolio loss for a recent down market for the selected risk score are displayed at step 104. A determination is made if the loss is acceptable at step 106. If the loss is not acceptable, the second individual may select another risk value at step 108. The second individual may also compare a selected risk value with previously compiled risk values of various demographic groups at step 110. When the loss and/or the demographic comparison are acceptable at step 112, the risk score is saved or stored for the second individual. As shown in FIG. 1, any number N of individuals may be included in the loss tolerance method.

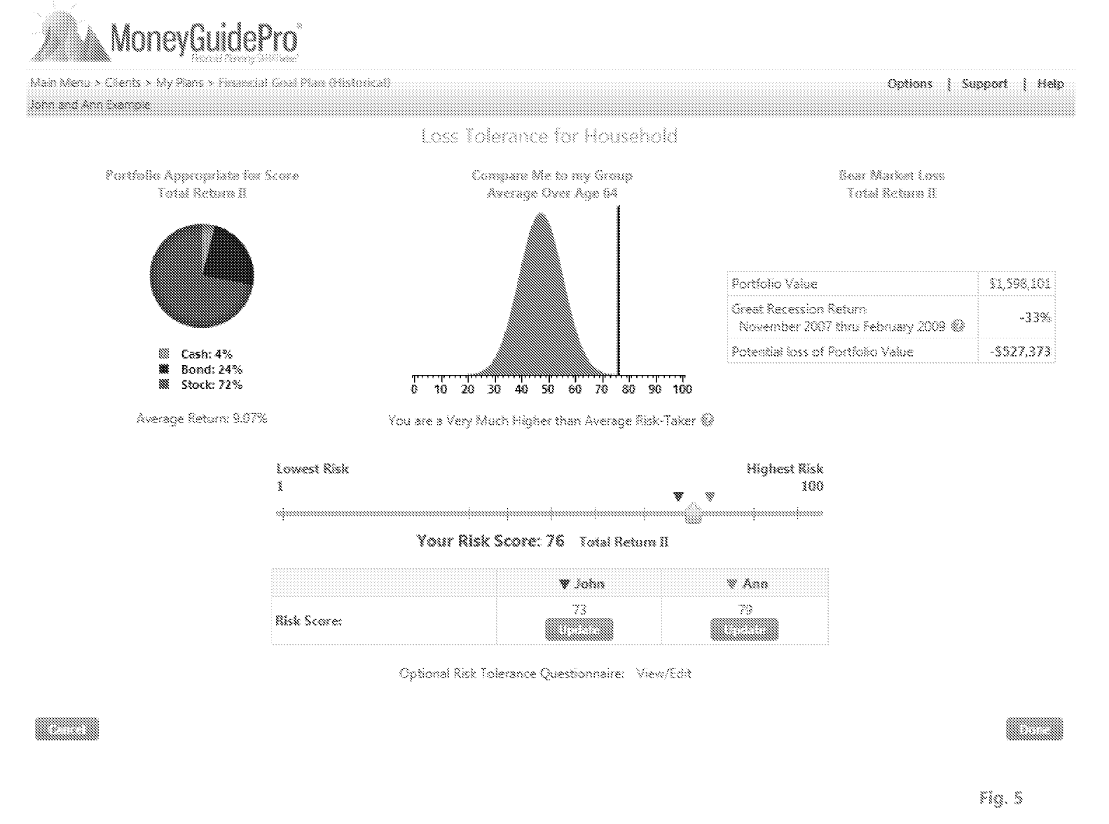

Once the risk values for the individuals have been established and saved, they may be combined at step 14 to obtain a composite value. In the examples shown in FIGS. 3 and 4 for John and Ann, the composite score is the average of the two risk scores which is 76 as shown in FIG. 5. The portfolio allocation and potential loss for the composite score is displayed at step 16. The combined scores are useful in providing financial counseling to couples, each of whom may have different risk scores. By preparing a composite score, the couples are shown a compromise portfolio allocation and the potential loss for that allocation. If the loss is not acceptable at step 18, the individuals have the opportunity to select different risk values at steps 8 and 108, respectively. The process may be repeated until an acceptable loss is determined.

Instead of using an average composite score, the couple may review their individual selected scores, which are identified on the scale shown in FIG. 5, and then select a score, which may be referred to as a household score, and which they agree is representative of their collective judgment.

If the loss is acceptable to the couple at step 18 in FIG. 1, the couple may also compare their composite score with those of other couples based on demographics at step 20 as described above.

Once the electronic device has displayed a portfolio that is acceptable to the couple (either because the potential loss is acceptable, or the demographic comparison is satisfactory, or both) at step 22, the couple can consult with the financial advisor to invest their funds in products which match the portfolio allocation.

By determining the downside risk that an individual is willing to tolerate, the individual is more likely to maintain investment objectives and is less likely to panic in the event of a downturn in financial markets that would result in a decrease in the portfolio. Displaying potential portfolio losses in dollars, in addition to a percentage of the portfolio, presents the individual with a “real world” picture of the potential losses associated with the risk score selected.

While the preferred forms and embodiments of the invention have been illustrated and described, it will be apparent to those of ordinary skill in the art that various changes or modifications may be made without deviating from the inventive concepts set forth above.

What is claimed is:

1. A method for determining the financial loss tolerance for at least one individual, comprising the steps of
(a) selecting a personal risk score for the individual on an electronic device;
(b) displaying the loss associated with the risk score during a recent down market on the electronic device; and
(c) determining whether the loss is acceptable to the individual.

2. A method as defined in claim 1, and further comprising the step of selecting a different personal risk score where the original score was not acceptable.

3. A method as defined in claim 2, and further comprising the step of displaying a portfolio allocation for the selected risk on the electronic device.

4. A method as defined in claim 2, and further comprising the step of displaying the risk scores for other individuals within a demographic group on the electronic.

5. A method as defined in claim 4, wherein said demographic group is based on at least one of age, gender and marital status.

6. A method as defined in claim 5, and further comprising the step of selecting a different personal risk score on the electronic device based on a comparison to the risk scores for other individuals within a demographic group.

7. A method as defined in claim 1, wherein the loss is displayed in dollars.

8. A method as defined in claim 1, wherein the loss is displayed as a percentage.

9. A method as defined in claim 1, wherein said selecting, displaying and determining steps are repeated for a second individual, and further comprising the steps of
(a) combining the risk scores to produce a composite risk tolerance score;
(b) displaying the loss associated with the risk score during a recent down market on the electronic device; and
(c) determining whether the loss is acceptable to the individuals.

10. A method as defined in claim 9, and further comprising the step of selecting a different personal risk score where the original score was not acceptable.

11. A method as defined in claim 9, and further comprising the step of displaying a portfolio allocation for the composite risk score on the electronic device.

12. A method as defined in claim 10, and further comprising the step of displaying the risk scores for other individuals within a demographic group on the electronic device.

13. A method as defined in claim 12, wherein said demographic group is based on at least one of age, gender and marital status.

14. A method as defined in claim 13, and further comprising the step of selecting a different personal risk score based on a comparison to the risk scores for other individuals within a demographic group.

15. A method as defined in claim 9, wherein said composite score is the average of said risk scores from the first and second individuals.
